(19) United States
(12) Patent Application Publication
(10) Pub. No.: US 2006/0003150 A1
(43) Pub. Date: Jan. 5, 2006

(54) Treatment of substrates for improving ink adhesion to substrates

(75) Inventors: Jaime Braverman, Atlanta, GA (US); Roberto C. Perez Bravo, Mexico City (MX)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 10/880,911

(22) Filed: Jun. 30, 2004

(51) Int. Cl. B41M 5/00

(52) U.S. Cl. 428/195.1

(57) ABSTRACT

Printed substrates and methods for treating substrates to improve the adhesion of an ink composition to a hydrophobic substrate are provided. The printed substrates include are treated with a surfactant, for example an ethoxylated hydrogenated castor oil or sorbitan monooleate. The method involves contacting at least a portion of a hydrophobic substrate with a composition that comprises an ethoxylated hydrogenated castor oil or sorbitan monooleate or a mixture thereof; and then printing a pattern or other indicia on at least a portion of the portion of the hydrophobic substrate that was contacted with surfactant.

### BACKGROUND

The present invention is directed to printed nonwoven fabrics, films, foams and to the treatment of nonwoven fabrics, films and foams to improve the adhesion of ink to the nonwoven fabrics, films and foams.

Polymers are used extensively to make a variety of products which include blown and cast films, extruded sheets, injection molded articles, foams, blow molded articles, extruded pipe, monofilaments, fibers and nonwoven fabrics. Polymers that are used to form theses, such as polyolefins, are naturally hydrophobic, and for many uses hydrophobicity is a disadvantage. Polyolefins, such as polyethylene and polypropylene, are used to manufacture polymeric fabrics which are employed in the construction of such disposable absorbent articles as diapers, feminine care products, incontinence products, training pants, wipes, and so forth. Such polymeric fabrics often are nonwoven fabrics prepared by, for example, such processes as melt-blowing, carding, coforming and spunbonding. These materials can be further combined with film substrates producing composites that can be used for specific applications such as outercovers for example. Since these materials are visible to the consumer, manufacturers look for ways to differentiate their products by adding features that can build brand recognition. One example of such product differentiation is printing on one or more components of the products, Therefore, it would be desirable to provide a method of improving the printability of polymeric substrates such as nonwoven fabrics made from polyolefin fibers.

Absorbent articles, especially personal care absorbent articles, such as diapers, training pants, and swimming pants typically include an outercover that made from a nonwoven polymeric fabric. The outercover of diapers, training pants, and swimming pants are difficult to print on in a fast and economical manner that is amenable to efficient machine production. More particularly, it is difficult to get good ink transfer and good ink adhesion to such hydrophobic substrates. Accordingly, there is a need to improve transfer and/or adhesion of inks to outercovers on diapers, training pants, feminine care outercovers, pouches, swimming pants and other products that incorporate hydrophobic substrates.

### Test Method

A crock test method was used to measure whether the combinations of treated nonwovens and inks had sufficient abrasion resistance. The crock test method was based upon American Association of Textile Chemists and Colorists (AATCC) Test Method 116-1983, which is incorporated herein in its entirety with a few modifications. The AATCC Test Method uses a device called a Rotary Vertical Crockmeter to rub a piece of test fabric against the sample specimen. This modified crock test method used a device called at Sutherland Rub Ink Tester as an alternative to the Crockmeter. The Sutherland Rub Tester is used in the printing industry to evaluate the resistance of inks and coatings on printed substrates. It has a broader test area than the crockmeter. The test head is 2-inches×4-inches for an eight square inch test area. The test head is moved laterally over the test specimen in a shallow arc pattern. Various weights are available to alter the pressure on the test surface and the number of test “strokes” is variable. This test method used an 8.0 pound weight and 40 rub strokes at a frequency of 42 cycles per minute. The test specimen can be abraded against any material that can be readily attached to the opposing surface of the tester.

Any transfer of colorant is qualitatively rated from one to five against a standard scale. A five is equivalent to the absence of transfer and a one is equivalent to an extreme amount of colorant transfer. The primary difference between the test method used in the following examples and the AATCC method was a quantitative method of assigning a colorfastness value. This crock test was performed using a Sutherland 2000 Rubtester supplied by Danilee Company of San Antonio, Tex. The results were compared to the AATCC Chromatic Transference Scale.

Equipment and Materials Used

1. Sutherland Rub Tester. Sharp edges on the vertical rod were filed to reduce abrasion of nonwoven materials.
2. Crockmeter cloth, standard 2-inch by 6-inch (approximately 50 millimeter by 152 millimeter) test squares.
3. Paper Cutter, standard 12-inch by 12 inch (305 mm×305 mm) minimum cutting area, obtained from Testing Machines, Inc., Amityville, New York.
4. Room with standard conditions atmosphere: temperature=23±1° C. (73.4±1.8° F.) and relative humidity=50±2 percent. Testing outside the specified limits for temperature and humidity may not yield valid results.
   Specimen Preparation

The test specimens were a spunbond polypropylene web and film laminate having a basis weight of about 1 ounce per square yard. The test specimens were cut exactly 2.5 inches wide by 7.0 inches long, unless otherwise noted, with the test area centered on the square.

Testing Procedure

1. Cut samples approximately 2.5 inches wide by 7.0 inches long in the machine direction of the substrate unless otherwise noted in the special instructions.
2. Label a white 2-inch×6-inch cotton sheet with the individual sample information. If sample is to be tested wet see instructions below.
3. Place the white cotton sheet lengthwise parallel to the direction of the rub. Adhere sample to the base of the machine.
4. Adhere white crockmeter cloth to 8.0 pound weight by placing the sample to be tested (matching long side to long side) on the weight and taping the excess with 610 tape. Be sure that the sample is taught and the printed side of material is to be facing out when taped on to the weight.
5. Place the weight (8.0 pounds) and white cloth sample on the rub tester arm.
6. Set the rub tester for 40 rub strokes at 40 cycles per minute.
7. Start the rub tester and wait for the tester to stop.
8. When the rub test for the sample is completed, staple the sample to the white cotton cloth with to a sheet of cardboard the sample behind the cloth.
9. Once the rub testing for a batch of samples is completed use the visual assessment MTCC 9 Step Chromatic Reference Sheet Spectrophotometer reading may begin.
10. Evaluate the area that appears to have the most amount of ink transfer, beginning with the white standard if necessary then proceeding through the batch. Place the AAT 9 Step Chromatic Reference Sheet on top of the area to be evaluated and back the white cotton specimen with several additional sheets of the cotton.
11. Number the sample during the reading consecutively from 1 to the end with number 1 being the white standard if necessary. These numbers should match the printout.
   Evaluation

Each specific ink formulation was tested multiple times to obtain an average reading. The average was determined by individually calculating the crockfastness rating for each of the test specimens, summing the crockfastness ratings, and then dividing by the number of samples to get the average crockfastness rating. The ink formulation was a PYROFLEX flexographic ink formulation obtained from Bemis Company, Inc., of Minneapolis, Minn.

### SUMMARY OF THE INVENTION

The present invention provides a printed polymeric substrate that includes a polymeric substrate, a coating or other surface treatment on at least a portion of the polymeric substrate, the coating comprising at least one surfactant composition and a pattern or other indicia comprising an ink composition printed on at least a portion of the portion of the polymeric substrate that is coated or surface treated with the surfactant. In certain embodiments, the polymeric substrate is hydrophobic, more desirably a hydrophobic nonwoven fabric, film, foam or a laminate including a hydrophobic nonwoven fabric, film, foam. For example, printed polymeric substrate may be or include a nonwoven fabric that includes fibers that include or are made from a polyolefin.

In an exemplary embodiment, the printed polymeric substrate is a breathable laminate of a nonwoven fabric and a film. Desirably, the laminate has a WVTR of at least about 100 g/m²/24 hours. The printed polymeric may form or be a component of a protective garment, a medical apparel article, a diaper, a training pant, a feminine care product, a package or a swimming pant. In illustrated embodiments, the surfactant has a HLB factor of about 10. In one embodiment, the treatment composition is selected from the group consisting of an ethoxylated hydrogenated castor oil and sorbitan monooleate, and mixtures thereof. Desirably, the surfactant composition includes both an ethoxylated hydrogenated castor oil and sorbitan monooleate. The surfactant composition may further include one or more botanical extracts or additives. Suggested botanical extracts include aloe vera, vitamin E, cotton extract, chamomile, jojoba, sunflower oil, citric oils, carrot oils, avocado oil, almond oil, wheat germ, mint, olive oil, vitamin E, vitamin D, vitamin A, isopropyl palmitate, eucalyptus oil, lavender, peppermint oil and derivatives thereof, and mixtures thereof. Other optional ingredients include, but are not limited to, alkyldemethyl benzylammonium chloride, allontoin (5-ureidohydantoin), aluminium acetate, aluminum hydroxide, amylum, balsam peru, benzethonium chloride, bismuth subnitrate, boric acid, calamine, calcium carbonate, camphor, casein, cod liver oil, cysteine hydrocholyde, dibucaine, disperodon, glycerin, lanolin, petrolatum, phenol, silic one sorbitane, talc, zinc oxide, zinc and so forth.

In another embodiment, the present invention provides a method of improving the adhesion of an ink composition to a hydrophobic substrate, the method includes: contacting at least a portion of a hydrophobic substrate with a composition that comprises a surfactant. A method of improving the adhesion of an ink composition to a hydrophobic substrate, the method is illustrated that includes: contacting at least a portion of a hydrophobic substrate with a composition that comprises a surfactant; and printing a pattern or other indicia on at least a portion of the portion of the hydrophobic substrate that was contacted with the surfactant. Suggested treatment compositions includes an ethoxylated hydrogenated castor oil, sorbitan monooleate, or a mixture thereof. The treatment composition further may further include a botanical extract selected from the group consisting of: aloe vera, vitamin E, cotton extract, derivatives of aloe vera, vitamin E, cotton extract, and derivatives and mixtures thereof. Other optional ingredients that may be included in the treatment composition are alkyldemethyl benzylammonium chloride, allontoin (5-ureidohydantoin), aluminium acetate, aluminum hydroxide, amylum, balsam peru, benzethonium chloride, bismuth subnitrate, boric acid, calamine, calcium carbonate, camphor, casein, cod liver oil, cysteine hydrocholyde, dibucaine, disperodon, glycerin, lanolin, petrolatum, phenol, silic one sorbitane, talc, zinc oxide, zinc and so forth.

In certain embodiments, the polymeric substrate is a hydrophobic film, foam or nonwoven substrate, for example the polymeric substrate may be a spunbonded nonwoven fabric or laminate of a spunbonded nonwoven fabric and another material for example a film.

In yet another embodiment, the present invention provides a method of improving the adhesion of an ink composition to a hydrophobic, spunbonded nonwoven substrate, the method including: forming a hydrophobic, spunbonded nonwoven substrate; contacting at least a portion of the hydrophobic, spunbonded nonwoven substrate with a composition that comprises a surfactant. For example, a method of improving the adhesion of an ink composition to a hydrophobic, spunbonded nonwoven substrate, the method comprising: forming a hydrophobic, spunbonded nonwoven substrate; contacting at least a portion of the hydrophobic, spunbonded nonwoven substrate with a treatment composition that comprises an ethoxylated hydrogenated castor oil, sorbitan monooleate and a botanical extract; and printing a pattern or other indicia on at least a portion of the portion of the hydrophobic, spunbonded nonwoven substrate that was contacted with the treatment composition is illustrated. The treatment composition may include optional components. Suggested optional components include botanical extract such as aloe vera, vitamin E, cotton extract, chamomile, jojoba, sunflower oil, citric oils, carrot oils, avocado oil, almond oil, wheat germ, mint, olive oil, vitamin D, vitamin A, isopropyl palmitate, eucalyptus oil, lavender, or peppermint oil, and derivatives thereof and mixtures thereof. One suggested botanical extract for including in the treatment compostion is aloe vera or cotton extract. In desirable embodiments, the substrate is a laminate of a film and a hydrophobic, spunbonded nonwoven substrate.

### BRIEF DESCRIPTION OF THE DRAWINGS

FIG. 1 illustrates an exemplary process for application of a treatment composition to a substrate.

FIG. 2 illustrates an exemplary dip and squeeze method of applying a treatment composition to a nonwoven fabric.

FIG. 3 schematically illustrates an exemplary foam treatment application system that provides zoned application.

FIG. 4 illustrates an exemplary zoned treatment application apparatus and system.

FIG. 5 is perspective view of an exemplary training pant.

FIG. 6 is an exploded cross-sectional view of FIG. 5 taken along line 6-6.

### DETAILED DESCRIPTION

Nonwoven fabrics, films, and foams are useful as components of absorbent products, personal care products, and health care products such as protective garments, other medical apparel, outercovers for diapers, outercovers for training pants, outercovers for swimming pants, packaging and so forth. Nonwoven fabrics, films, foams and other components of such disposable products are frequently made of or from synthetic polymers, particularly polyolefins such as polypropylene and polyethylene and mixtures including either or both polyolefins. Synthetic polymers, such as polyolefins are hydrophobic and difficult to print on. Nonwoven substrates made with hydrophobic synthetic polymers are particularly difficult to print on. The present invention provides printed nonwoven fabrics, films, and foams and also provides compositions and methods for treating such hydrophobic substrates to improve the printability of ink on the substrates.

As used herein, the term “hydrophobic substrate” is meant to include any shaped article, provided it is composed, in whole or in part, of a hydrophobic polymer and the term “porous hydrophobic substrate” is meant to include any substrate, provided it is porous and composed, in whole or in part, of a hydrophobic polymer. For example, the hydrophobic substrate may be a sheet-like material, such as a sheet of a foamed material. The hydrophobic substrate also may be a fibrous fabric, such as fibrillated film or a woven or nonwoven web or fabric. These structures can be predominately hydrophobic or can be selectively treated exhibiting different hydrophobic zones. Nonwoven fabrics include, but are not limited to, a meltblown fabric, a spunbonded fabric, a carded fabric or an airlaid fabric. The hydrophobic substrate also may be a laminate of two or more layers of a sheet-like material. For example, the layers may be independently selected from the group consisting of meltblown fabrics and spunbonded fabrics. However, other sheet-like materials such as films or foams may be used in addition to, or instead of, meltblown and spunbonded fabrics. In addition, the layers of the laminate may be prepared from the same hydrophobic polymer or different hydrophobic polymers.

The substrate of the present invention may be a nonwoven fabric, a film or a foam or a laminate of a nonwoven fabric, a film or a foam. In one group of embodiment, the substrate is a hydrophobic nonwoven fabric that includes synthetic fibers, particularly polyolefin fibers. According to the present invention, a nonwoven fabric is contacted with a treatment composition that includes one or more surfactants, for example an ethoxylated hydrogenated castor oil, sorbitan monooleate or a combination that includes one or both of these surfactants. In an exemplary embodiment, a nonwoven fabric made from hydrophobic synthetic fibers, such as polypropylene fibers, is contacted with an aqueous or nonaqueous composition that includes a surfactant to provide a more printable polyolefin nonwoven fabric. The polyolefin fibers that form the fabric may include polyethylene and/or polypropylene fibers and fibers produced from compositions and blends that include a polyethylene and/or a polypropylene resin and can be produced by various known methods.

Methods of making films, foams and nonwoven fabrics from synthetic polymers, are well known. Films, foams, nonwoven fabrics and other substrates generally may be prepared by any known means. As a practical matter, however, the films, nonwoven fabrics and the fibers that make up nonwoven fabrics usually will be prepared by a melt-extrusion process and formed into a film or fibrous fabric, such as a nonwoven fabric.

The term “melt-extrusion process” as applied to a nonwoven fabric is meant to include a nonwoven fabric prepared by any melt-extrusion process for forming a nonwoven fabric in which melt-extrusion to form fibers is followed by fabric formation, typically concurrently, on a porous support. The term includes, among others, such well-known processes as meltblowing, coforming, spunbonding, and so forth. By way of illustration only, such processes are exemplified by the following references: meltblowing references include, by way of example, U.S. Pat. No. 3,016,599 to R. W. Perry, Jr., U.S. Pat. No. 3,704,198 to J. S. Prentice, U.S. Pat. No. 3,755,527 to J. P. Keller et al., U.S. Pat. No. 3,849,241 to R. R. Buntin et al., U.S. Pat. No. 3,978,185 to R. R. Buntin et al., and U.S. Pat. No. 4,663,220 to T. J. Wisneski et al. See, also, V. A. Wente, “Superfine Thermoplastic Fibers”, Industrial and Engineering Chemistry, Vol. 48, No. 8, pp. 1342-1346 (1956); V. A. Wente et al., “Manufacture of Superfine Organic Fibers”, Navy Research Laboratory, Washington, D.C., NRL Report 4364 (111437), dated May 25, 1954, United States Department of Commerce, Office of Technical Services; and Robert R. Buntin and Dwight T. Lohkamp, “Melt Blowing—A One-Step Fabric Process for New Nonwoven Products”, Journal of the Technical Association of the Pulp and Paper Industry, Vol. 56, No. 4, pp. 74-77 (1973); coforming references include U.S. Pat. No. 4,100,324 to R. A. Anderson et al. and U.S. Pat. No. 4,118,531 to E. R. Hauser; and spunbonding references include, among others, U.S. Pat. No. 3,341,394 to Kinney, U.S. Pat. No. 3,655,862 to Dorschner et al., U.S. Pat. No. 3,692,618 to Dorschner et al., U.S. Pat. No. 3,705,068 to Dobo et al., U.S. Pat. No. 3,802,817 to Matsuki et al., U.S. Pat. No. 3,853,651 to Porte, U.S. Pat. No. 4,064,605 to Akiyama et al., U.S. Pat. No. 4,091,140 to Harmon, U.S. Pat. No. 4,100,319 to Schwartz, U.S. Pat. No. 4,340,563 to Appel and Morman, U.S. Pat. No. 4,405,297 to Appel and Morman, U.S. Pat. No. 4,434,204 to Hartman et al., U.S. Pat. No. 4,627,811 to Greiser and Wagner, and U.S. Pat. No. 4,644,045 to Fowells.

Other methods for preparing nonwoven fabrics are, of course, known and may be employed. Such methods include air laying, wet laying, carding, and so forth. In some cases it may be either desirable or necessary to stabilize the nonwoven fabric by known means, such as thermal point bonding, through-air bonding, and hydroentangling. In addition to nonwoven fabrics, the hydrophobic polymer fibers may be in the form of continuous filaments or staple fibers, as well as woven or knitted fabrics prepared from such continuous filaments or staple fibers. Furthermore, the nonwoven fabric may include bicomponent or other multicomponent fibers. Exemplary multicomponent nonwoven fabrics are described in U.S. Pat. No. 5,382,400 issued to Pike et al., U.S. patent application Ser. No. 10/037,467 entitled “High Loft Low Density Nonwoven Fabrics Of Crimped Filaments And Methods Of Making Same” and U.S. patent application Ser. No. 10/136,702 entitled “Methods For Making Nonwoven Materials On A Surface Having Surface Features And Nonwoven Materials Having Surface Features” which are hereby incorporated by reference herein in their entirety. Sheath/core bicomponent fibers where the sheath is a polyolefin such as polyethylene or polypropylene and the core is polyester such as poly(ethylene terephthalate) or poly(butylene terephthalate) can also be used to produce carded fabrics or spunbonded fabrics. The primary role of the polyester core is to provide resiliency and thus to maintain or recover bulk under/after load. Bulk retention and recovery plays a role in separation of the skin from the absorbent structure. This separation has shown an effect on skin dryness. The combination of skin separation provided with a resilient structure along with a treatment such of the present invention can provide an overall more efficient material for fluid handling and skin dryness purposes.

The term “hydrophobic polymer” is used herein to mean any polymer resistant to wetting, or not readily wet, by water, i.e., having a lack of affinity for water. Examples of hydrophobic polymers include, by way of illustration only, polyolefins, such as polyethylene, poly(isobutene), poly(isoprene), poly(4-methyl-1-pentene), polypropylene, ethylene-propylene copolymers, ethylene-propylene-hexadiene copolymers, and ethylene-vinyl acetate copolymers; styrene polymers, such as poly(styrene), poly(2-methylstyrene), styrene-acrylonitrile copolymers having less than about 20 mol-percent acrylonitrile, and styrene-2,2,3,3,-tetrafluoropropyl methacrylate copolymers; halogenated hydrocarbon polymers, such as poly(chlorotrifluoroethylene), chlorotrifluoroethylene-tetrafluoroethylene copolymers, poly(hexafluoropropylene), poly(tetrafluoroethylene), tetrafluoroethylene-ethylene copolymers, poly(trifluoroethylene), poly(vinyl fluoride), and poly(vinylidene fluoride); vinyl polymers, such as poly(vinyl butyrate), poly(vinyl decanoate), poly(vinyl dodecanoate), poly(vinyl hexadecanoate), poly(vinyl hexanoate), poly(vinyl propionate), poly(vinyl octanoate), poly(heptafluoroisopropoxyethylene), poly(heptafluoroisopropoxypropylene), and poly(methacrylonitrile); acrylic polymers, such as poly(n-butyl acetate), poly(ethyl acrylate), poly[(1-chlorodifluoromethyl)tetrafluoroethyl acrylate], poly[di(chlorofluoromethyl)fluoromethyl acrylate], poly(1,1-dihydroheptafluorobutyl acrylate), poly(1,1-dihydropentafluoroisopropyl acrylate), poly(1,1-dihydropentadecafluorooctyl acrylate), poly(heptafluoroisopropyl acrylate), poly[5-(heptafluoroisopropoxy)pentyl acrylate], poly[11-(heptafluoroisopropoxy)undecyl acrylate], poly[2-(heptafluoropropoxy)ethyl acrylate], and poly(nonafluoroisobutyl acrylate); methacrylic polymers, such as poly(benzyl methacrylate), poly(n-butyl methacrylate), poly(isobutyl methacrylate), poly(t-butyl methacrylate), poly(t-butylaminoethyl methacrylate), poly(dodecyl methacrylate), poly(ethyl methacrylate), poly(2-ethylhexyl methacrylate), poly(n-hexyl methacrylate), poly(phenyl methacrylate), poly(n-propyl methacrylate), poly(octadecyl methacrylate), poly(1,1-dihydropentadecafluorooctyl methacrylate), poly(heptafluoroisopropyl methacrylate), poly(heptadecafluorooctyl methacrylate), poly(1-hydrotetrafluoroethyl methacrylate), poly(1,1-dihydrotetrafluoropropyl methacrylate), poly(1-hydrohexafluoroisopropyl methacrylate), and poly)t-nonafluorobutyl methacrylate); and polyesters, such a poly(ethylene terephthalate) and poly(butylene terephthalate).

The term “polyolefin” is used herein to mean a polymer prepared by the addition polymerization of one or more unsaturated monomers which contain only carbon and hydrogen atoms. Examples of such polyolefins include polyethylene, polypropylene, poly(1-butene), poly(2-butene), poly(1-pentene), poly(2-pentene), poly(3-methyl-1-pentene), poly(4-methyl-1-pentene), and so forth. In addition, such term is meant to include blends of two or more polyolefins and random and block copolymers prepared from two or more different unsaturated monomers. Because of their commercial importance, the most desired polyolefins are polyethylene and polypropylene. The polyolefin may contain additives as is known or customary in the art. For example, the polyolefin may contain pigments, opacifiers, fillers, delustrants, antioxidants, antistatic agents, stabilizers, oxygen scavengers, and so forth. Fibers made with polyolefin's can be made as monoconstituent of biconstituent depending on the final characteristics that are desired in the product.

In one embodiment, the present invention relates to treatment compositions, printed polymeric substrates and methods of improving the adhesion of an ink composition to a hydrophobic substrate that includes: contacting, desirably coating, at least a portion of a hydrophobic substrate with a composition that comprises a surfactant; and printing a pattern or other indicia on at least a portion of the portion of the hydrophobic substrate that was contacted with the surfactant. Suggested surfactants include, but are not limited to, chemistries having HLB values of about 10 and so forth. Examples of such surfactants were obtained from Union Carbide under the designation AHCOVEL N-62 and from Uniquema of Wilmington, Del. under the designation CIRRASOL PP823 and CIRRASOL PP1022.

Suggested surfactants and combinations of surfactants preferably have a hydrophilic/lyophilic balance number (HLB) of at least about 10, more preferably, it has an HLB of at least about 12, and most preferably, it has an HLB of at least about 15. As used herein, the term “hydrophilic agent” refers to a substance that may readily associate with water, and the term “lyophilic agent” refers to an agent that may attract liquids in a colloid system, describing a colloidal system in which the dispersed phase may be a liquid and attracts the dispersing medium. Hydrophilic agents that do not generally have a measured HLB may also be used. Such hydrophilic agents may include, without limitation, diols, such as glycols and polyglycols.

Suitable nonionic surfactants include, but are not intended to be limited to, C₂₋₈ diols and polyglycols, and the like. Generally, the diol may be selected from the group consisting of glycols (C₂ and C₃ diols) and polyglycols. The term “polyglycol” refers to a dihydroxy ether formed by dehydration of two or more glycol molecules. A representative, non-limiting list of useful polyglycols, includes ethylene glycol, propylene glycol, polyethylene glycols, polypropylene glycols, methoxypolyethylene glycols, polybutylene glycols, or block copolymers of butylene oxide and ethylene oxide. Among the aforementioned polyglycols, polyethylene glycol having a molecular weight of less than equal to about 600, and polypropylene glycol having a molecular weight of less than equal to about 4,000, may be generally preferred. A polyglycol that may be liquid at room temperature is generally most preferred.

Other suitable nonionic surfactants include ethoxylates, including fatty acid ester ethoxylates, fatty acid ether ethoxylates, and ethoxylated sugar derivatives, e.g., ethoxylated fatty acid polyesters, ethoxylated fatty acid sorbitan esters, and the like. Representative ethoxylated fatty acid sorbitan esters include polyoxyethylene sorbitan laurate (also known as Polysorbate 20 (HLB: 16.7) and 21(HLB: 13.3)), polyoxyethylene sorbitan palmitate (also known as Polysorbate 40 (HLB: 15.6)), polyoxyethylene sorbitan stearate (also known as Polysorbate 60 (HLB: 14.9) and 61 (HLB: 9.6)), polyoxyethylene sorbitan tristearate (also known as Polysorbate 65 (HLB: 10.5)), polyoxyethylene sorbitan oleate (also known as Polysorbate 80 (HLB: 15.0) and 81 (HLB: 10.0)), and polyoxyethylene sorbitan trioleate (also known as Polysorbate 85 (HLB:11.0)). Among the aforementioned ethoxylated fatty acid sorbitan esters, polyoxyethylene-20-sorbitan monolaurate is generally preferred.

Another generally used class of ethoxylated fatty acid ethers may be the class of polyoxyethylene alkyl ether. A representative, non-limiting list of useful polyoxyethylene alkyl ethers, includes polyoxyethylene lauryl ether, polyoxyethylene stearyl ether (also known as Steareth-2, Steareth-10 (HLB: 12.4), and the like), polyoxyethylene cetyl ether (also known as Ceteth-2, Ceteth-10 (HLB: 12.9), and the like), and polyoxyethylene oleyl ether (also known as Oleth-2 (HLB: 12.4), Oleth-10, and the like). Among the aforementioned polyoxyethylene alkyl ethers, polyoxyethylene stearyl ether is most generally preferred. Another generally used class of fatty acid esters may be the class of sorbitan fatty acid esters. A representative, non-limiting list of useful sorbitan fatty acid esters, includes sorbitan monooleate (HLB: 4.3), sorbitan monostearate (HLB: 4.7), sorbitan monopalmitate (HLB: 6.7), sorbitan monolaurate (HLB: 8.6), sorbitan tristearate (HLB: 2.1), and sorbitan trioleate (HLB: 1.8). Among the aforementioned sorbitan fatty acid esters, sorbitan monooleate is the most generally preferred. Another generally used class of ethoxylated sugar derivatives may be the class of methyl glucose derivatives. A representative, non-limiting list of useful methyl glucose derivatives, includes methyl glucose-10, methyl glucose-20, methyl glucose-20 distearate, methyl glucose dioleate (HLB: 5), and methyl glucose sesquistearate (HLB: 6), PEG-120 methyl glucose dioleate, and PEG-20 methyl glucose sesquistearate.

Suitable surfactant combinations that are commercially available include those marketed under the registered trademarks “SPAN” (sorbitan derivatives), “TWEEN” (polysorbate derivatives), and “BRIJ” (polyoxyethylene oleyl ethers) by Uniqema, a division of ICI, Wilmington, Del., USA and those surfactants marketed under the registered trademarks “GLUCAM” (methyl glucose ethers), “GLUCATE” (methyl glucose derivatives), and “GLUCAMATE” (polyethyleneglycol ethers of methyl glucoses) by Amerchol Corporation of Edison, New Jersey. It is suggested that the surfactant treatment is an aqueous solution and is applied to a substrate at an add on rate of from about 0.1 weight percent to about 3 weight percent surfactant relative to the weight of the substrate.

Treatment compositions of the present invention may include other optional ingredients for example a botanical extract. Suggested examples of botanical extracts include, but are not limited to: chamomile, aloe vera, jojoba, sunflower oil, citric oils, carrot oils, avocado oil, almond oil, cotton extract, wheat germ, mint, olive oil, vitamin E, vitamin D, vitamin A isopropyl palmitate, eucalyptus oil, lavender, peppermint oil, and so forth. Treatment compositions of the present invention may include a combination of botanical extracts or a combination that includes at least one botanical extract. The botanical extracts may be from at about 0.05 weight percent to about 30 weight percent of the surfactant composition. In addition, other optional ingredients may be incorporated in the treatment solution. Suggested optional ingredients include, but are not limited to, alkyldemethyl benzylammonium chloride, allontoin (5-ureidohydantoin), aluminium acetate, aluminum hydroxide, amylum, balsam peru, benzethonium chloride, bismuth subnitrate, boric acid, calamine, calcium carbonate, camphor, casein, cod liver oil, cysteine hydrocholyde, dibucaine, disperodon, glycerin, lanolin, petrolatum, phenol, silic one sorbitane, talc, zinc oxide, zinc and so forth.

The method of forming or coating the treatment composition on the substrate may vary and can be varied in a controlled manner across at least one dimension of a porous substrate. For example, the treatment that includes the surfactant may applied to on only one side of a substrate and may only be applied on a portion of one side of a substrate, for example on a central or other smaller region that is desired to be printed on. Thus, the coating or treatment of a substrate would vary in a controlled manner across the width thereof. Other variations coming within the scope of the present invention will be readily apparent to those having ordinary skill in the art, for example prior or post corona treatment can also be applied to further improve adhesion of the treatment and the ink(s) to the substrate.

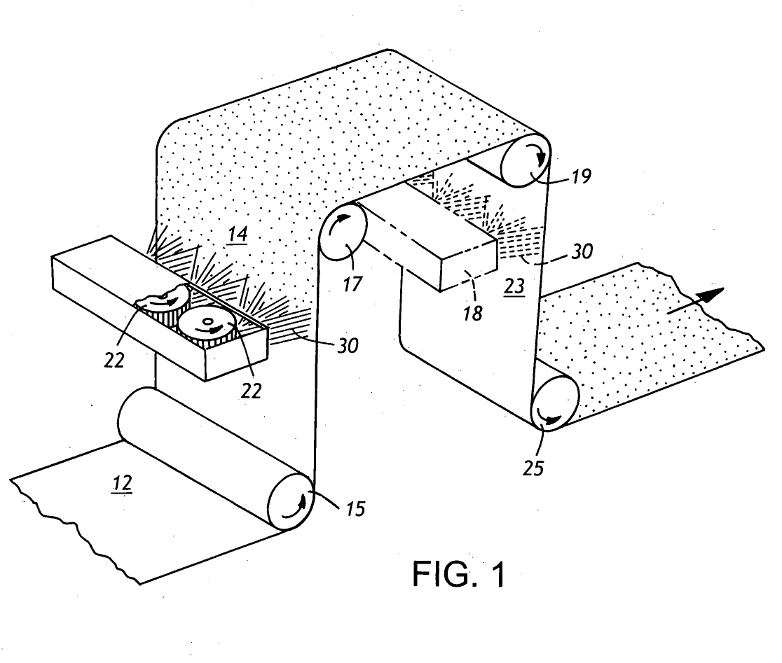

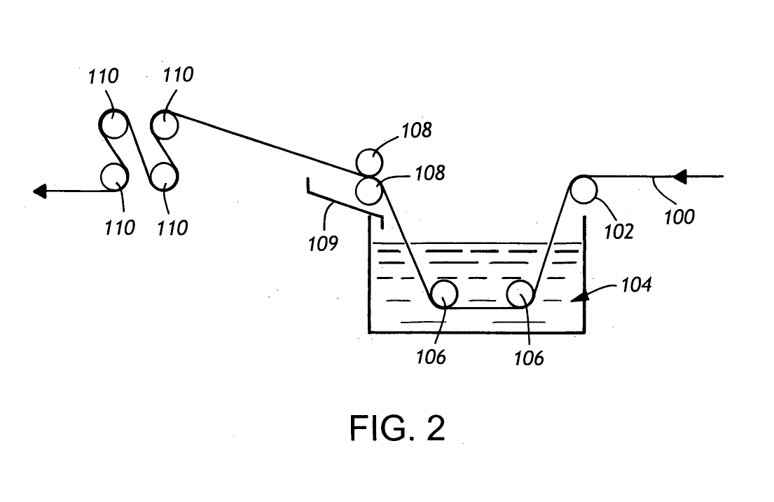

Turning now to an exemplary method for preparing a treated porous substrate, the method involves providing a porous hydrophobic polymer substrate and exposing at least a portion of the substrate to a mixture that includes at least one surfactant. A suggested combination of surfactants includes contacting the porous substrate with a surfactant mixture that includes hydrogenated castor oil and sorbitan monooleate. Again, the treatment composition may further include other components, such as wetting agents, emulsifiers, lubricants, anti-stats, skin care ingredients, anti-oxidants, vitamins, botanical extracts, scents, odor control agents, color, and anti-microbials. Exemplary methods of treating a substrate with treatment compositions are provided in the figures where FIG. 1 illustrates a first exemplary process that sprays a treatment composition on a substrate and FIG. 2 illustrates a second, exemplary “dip and squeeze” process of applying a treatment composition to a substrate. Persons of skill in the art would appreciate that other methods of applying treatment compositions such as spraying, printing foaming, or applying the treatment composition with a kiss roll, flexography or by rotogravure can be used with the present invention. In addition, it may be desirable to further pretreat the substrate, for example by exposing the substrate with corona or plasma treatment, prior contacting the substrate with the surfactant or mixture of surfactants.

Referring to FIG. 1, an exemplary process for applying a treatment composition of the present invention to one or both sides of a traveling fabric will be described. It should be appreciated by those skilled in the art that the invention is equally applicable to inline treatment or a separate, offline treatment step. Fabric 12, for example a laminate of a spunbonded nonwoven fabric and a film, is directed under support roll 15 to a treating station including rotary spray heads 22 for application to one side 14 of fabric 12. Examples of breathable laminates of a spunbonded nonwoven fabric and a film and methods of making such laminates are described in U.S. Pat. Nos. 5,695,868; 5,855,999; 6,075,179; 5,837,352; 5,955,187; 6,037,281; 5,900,306; 5,910,136; 5,914,184; 5,993,589; 5,843,057; 6,015,764; 6,111,163; 6,096,014; 5,947,944; 6,002,064; 6,072,005; 5,997,981; 5,800,758; 6,045,900; 5,932,497; 6,096,668; 6,114,024; 5,882,769; 5,843,056; and 6,309,736. An optional treating station 18 (shown in phantom) which includes rotary spray heads can also be used to apply the same treatment composition or another treatment composition to opposite side 23 of fabric 12 directed over support rolls 17 and 19. Each treatment station receives a supply of treating liquid 30 from a reservoir (not shown).

As used herein, the term “breathable” refers to a material which is permeable to water vapor having a minimum WVTR (water vapor transmission rate) of about 100 g/m²/24 hours, more desirably having a minimum WVTR of about 1000 g/m²/24 hours or in some specific cases the WVTR can be as high as 15000 g/m²/24 hours. The WVTR of a fabric, in one aspect, gives an indication of how comfortable a fabric would be to wear. WVTR is measured as indicated below and the results are reported in grams/square meter/24 hours. However, often applications of breathable barriers desirably have higher WVTRs and breathable barriers of the present invention can have WVTRs exceeding about 1,200 g/m²/24 hours, 1,500 g/m²/24 hours, 1,800 g/m²/24 hours or even exceeding 2,000 g/m²/24 hours. The water vapor transmission rate (WVTR) for sample materials is calculated in accordance with the following test method. Circular samples measuring three inches in diameter were cut from each of the test materials and a control which was a piece of CELGARD® 2500 film from Hoechst Celanese Corporation of Sommerville, New Jersey. CELGARD® 2500 film is a microporous polypropylene film. Three samples were prepared for each material. The test dish was a number 60-1 Vapometer pan distributed by ThwingAlbert Instrument Company of Philadelphia, Pa. One hundred milliliters of water were poured into each Vapometer pan and individual samples of the test materials and control material were placed across the open tops of the individual pans. Screw-on flanges were tightened to form a seal along the edges of the pan, leaving the associated test material or control material exposed to the ambient atmosphere over a 6.5 centimeter diameter circle having an exposed area of approximately 33.17 square centimeters. The pans were placed in a forced air oven at about 100° F. (38° C.) or 1 hour to equilibrate. The oven was a constant temperature oven with external air circulating through it to prevent water vapor accumulation inside. A suitable forced air oven is, for example, a Blue M Power-O-Matic 60 oven distributed by Blue M. Electric Company of Blue Island, Illinois. Upon completion of the equilibration, the pans were removed from the oven, weighed and immediately returned to the oven. After 24 hours, the pans were removed from the oven and weighed again. The preliminary test water vapor transmission rate values were calculated with the following equation:
Test WVTR=(grams weight loss over 24 hours)×315.5 g/m²/24 hours
The relative humidity within the oven was not specifically controlled. Under the predetermined set conditions of about 100° F. (38° C.) and ambient relative humidity, the WVTR for the CELGARDO 2500 control has been defined to be 5000 grams per square meter for 24 hours. Accordingly, the control sample was run with each test and the preliminary test values were corrected to set conditions using the following equation:
WVTR=(Test VWTR/control WVTR)×(5000 g/m²/24 hours).

Either or both treating stations may include a rotary spray system that applies the treatment composition. An exemplary spray system is illustrated in FIGS. 1, 3 and FIG. 4 illustrates an exemplary rotary spray zoned treatment application apparatus and system. A suggested system and apparatus that includes the components illustrated in the figures includes a “WEKO” system. The WEKO system and apparatus can be obtained from WEKO, Biel AG, Switzerland. The configuration includes a centrifugal damping application system using a single or double rotocarrier. The surfactant formulation is pumped to the header through a gear pump where it is fed to the damping rotors through restrictor tubes. The system is equipped with a series of rotors 50, which spin at a speed of about 4500 rpm. Under the effect of a centrifugal force generated by the spinning rotors 50, a treatment composition can be dispensed to the nonwoven fabric or other substrate 52 in the form of an aerosol or small droplets 54. Throughput as measured in gram/minute is controlled and adjusted with different diameter restrictor tubes, header pressure and bath parameters (e.g. concentration and temperature). Additionally, finer throughput control can be achieved by adding optional needle valves to the outlet ports of the header. If a zone treatment is desired, templates 60 made of stainless steel or another solid material of a predetermined width are placed in front of the fabric so that the spray is applied to the material only through the template opening(s) 62. A suggested template opening is 4 inches and provides a 4-inch wide treated zone 53 to a nonwoven material 52.

The treated fabric may then be dried if needed by passing over dryer cans (not shown) or other drying means and then under support roll 25 to be wound as a roll or converted to the use for which it is intended. For a polypropylene fabric, drying can be achieved by heating the treated fabric to a temperature from about 220° F. to 300° F., more desirably to a temperature from 270° F. to 290° F., by passage over a heated drum to set the treatment composition and complete drying. Drying temperatures for other polymers will be apparent to those skilled in the art. Alternative drying means include ovens, through air dryers, infrared dryers, air blowers, and so forth. In some cases drying may not be required.

FIG. 2 illustrates an alternative arrangement and method of applying a treatment composition of the present invention. The process illustrated in FIG. 2 is refereed to as a “dip and squeeze” process. In the dip and squeeze process, the substrate is saturated with a bath containing the treating formulation, typically by immersing the substrate in the bath. The saturated material can then be nipped at a controllable pressure between two rubber rollers to remove excess saturant. Bath concentration, nip pressure and line speed are parameters that control add-on level on the fabric. Add-on level is measured by gravimetric analysis using the following equations 1 and 2.
% Wet Pick Up (WPU)=[(W_{w}−W_{d})/W_{d}]×100 (Equation 1)
and
Wt % Add-on=% WPU×C (Equation 2)
where,
W_{w}=Wet weight of the substrate after saturation and nipping (grams)
W_{d}=Dry weight of treated substrate (grams)
C=bath chemical concentration (wt %)
   The nip between squeeze rolls 108 removes excess treating composition which is returned to the bath by catch pan 109. Drying cans 110 remove remaining moisture. If more than one treatment composition is employed, the dip and squeeze may be repeated and the fabric 100 can be forwarded to and immersed in additional baths (not shown). Suggested add-on weight of the treatment composition on the substrate are from about 0.1 weight percent to about 3 weight percent.

The dried, treated substrate can be printed on by a variety of printing methods. Suggested printing methods include, but are not limited to, flexographic printing, in jet printing, screen printing, lithographic printing and gravure printing methods. The present invention desirably utilizes a flexographic printing method to provide the proper balance of cost effective, high speed, high quality printing suitable for printing nonwoven fibrous webs, while maintaining the tactile softness of the web. Flexographic printing is a printing technology that is well known. Generally, flexographic printing uses flexible raised rubber or photopolymer plates to carry an image to a given substrate. The flexible plates carry a typically low-viscosity ink directly onto the substrate. Ink compositions for printing are well known. Ink compositions suitable for printing on hydrophobic polyolefin based materials are also known. For example, ink compositions for printing on polyolefin-based nonwoven and film substrates are described in U.S. Pat. No. 5,458,890, which is hereby incorporated by reference herein in their entireties. The ink composition may be a conventional ink formulation and may additional, optional components.

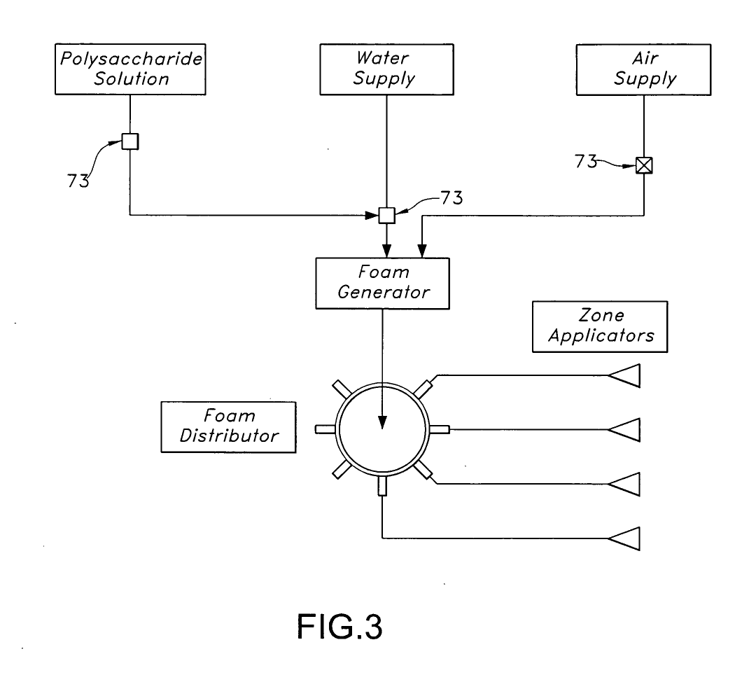

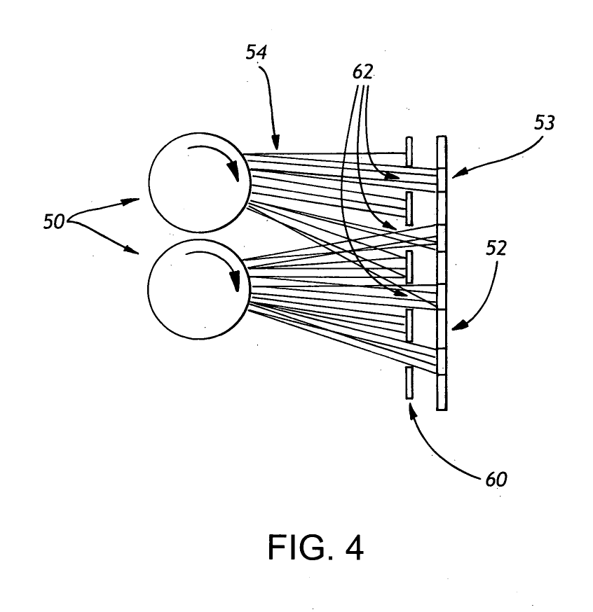

Another process that can be used to apply treatment compositions of the present invention to a substrate includes a foaming process. Foaming is a desirable process because of its efficiency, ease of operation, cleanliness, and good control over process parameters. A general schematic diagram of a foam process is shown in FIG. 3 and includes chemical tanks, air and water supplies, and metering devices (e.g. pumps, valves and flow meters) connected to a high shear-mixing chamber. Suggested foam equipment can be obtained from Gaston Systems, Incorporated of Stanley, North Carolina. This equipment includes a parabolic foam applicator with a ⅛ inch slot opening and a slot width that is adjustable from about 11 inches to about 18 inches, but can be as wide as 120 inches or more. This kind of foam equipment is capable of full width treatment or zone treatment. The zone treatment is achieved by using foam applicator of a specific width, e.g. 4 inches wide. In the case of zone treatment multiple 4 inch wide foam applicators can be used to simultaneously treat multiple slits of a nonwoven base roll as illustrated in FIGS. 3 and 4. Various other methods may be employed for contacting a substrate with the treatment composition or compositions in accordance with the invention. For example, a substrate may be printed on by means of print rolls, slot coating or other conventional coating techniques.

In a desirable embodiment, a nonwoven fabric or a portion of a nonwoven fabric is treated according to a method of the present invention wherein the nonwoven fabric is contacted with a surfactant selected from the group consisting of an ethoxylated hydrogenated castor oil, sorbitan monooleate, and mixtures thereof in order to improve the adhesion and retention of an ink composition to the nonwoven fabric. The treated portion of the nonwoven fabric may then be printed with an ink composition. Alternatively, a nonwoven fabric can be formed with fibers treated with an ethoxylated hydrogenated castor oil, sorbitan monooleate, or a mixture including either or both. The treated nonwoven fabric can be incorporated into a personal care product, such as an outercover of a diaper or other personal care product, to provide printed or printable product such a diaper having a printed character on the front portion of the outercover of the diaper. Treated nonwoven fabrics of the present invention may vary in basis weight and/or density and may be applicable to a variety of applications including, but not limited to, components of various personal care and absorbent products, for example diapers, swimming pants, training pants, surgical drapes, medical garments, wipers such as infant wipers and clean room wipers, feminine care outercovers, pouches, packaging materials and so forth.

The treated nonwoven fabric can be printed by a variety of know printing methods including, but not limited to, flexographic and rotogravure printing methods. Although flexographic printing is suggested, other printing processes and apparatus or combinations thereof are also contemplated by the present invention. These other printing processes include screen printing, rotogravure printing in which an engraved print roll is utilized, and ink jet printing in which nozzles spray ink droplets that are selectively deflected by an electrostatic charge to form the desired pattern on the substrate. The ink selection and formulation can vary and the selection and testing of various inks is within the skill of a person of skill in the art. Ink compositions containing organic solvents which evaporate and dry quickly are suggested as well as nitrocellulose inks.

The inks used in the printing process to form the indicia are preferably particulate-type inks. The inks chosen should, of course, be safe for human use and should not have environmentally deleterious effects. Moreover, it is desirable that the ink composition is suitable for the intended printing process and is preferably temperature resistant to the process employed for forming the absorbent article, e.g., the temperatures used during a vacuum aperturing process and the like elevated heating processes. The particulate inks preferably comprises inert pigments and dyes, collectively referred to as pigments, which may be added in levels of about greater than equal to about 0.25 percent to about less than equal to about 40 percent on a dry weight basis and preferably between greater than equal to about 1 percent and less than equal to about 10 percent.

Suitable pigments include azo dyes (e.g., Solvent Yellow 14, Dispersed Yellow 23, and Metanil Yellow), anthraquinone dyes (e.g., Solvent Red 111, Dispersed Violet 1, Solvent Blue 56, and Solvent Orange 3), xanthene dyes (e.g., Solvent Green 4, Acid Red 52, Basic Red 1, and Solvent Orange 63), azine dyes (e.g., Jet Black), and the like. Other suitable organic pigments, include dairylide yellow AAOT (for example, Pigment Yellow 14 CI No. 21095), dairylide yellow MOA (for example, Pigment Yellow 12 CI No. 21090), Hansa Yellow, CI Pigment Yellow 74, Phthalocyanine Blue (for example, Pigment Blue 15), lithol red (for example, Pigment Red 52:1 CI No. 15860: 1). toluidine red (for example. Pigment Red 22 CI No. 12315), dioxazine violet (for example, Pigment Violet 23 CI No. 51319), phthalocyanine green (for example, Pigment Green 7 CI No. 74260), phthalocyanine blue (for example, Pigment Blue 15 CI No. 74160), naphthoic acid red (for example, Pigment Red 48:2 CI No. 15865:2). Inorganic pigments include titanium dioxide (for example, Pigment White 6 CI No. 77891), carbon black (for example, Pigment Black 7 CI No. 77266), iron oxides (for example, red, yellow. and brown), ferric oxide black (for example, Pigment Black 11 CI No. 77499), chromium oxide (for example, green), ferric ammonium ferrocyanide (for example, blue), and the like. In an exemplary embodiment, the preferred method of imprinting the ink onto the cover layer 12 is flexographic printing to provide the proper balance of cost effective, high speed, high quality printing suitable for printing, the polymeric film. Flexography is a printing technology, which uses flexible raised rubber plates or photopolymer plates to carry the image to the film. The flexible plates generally carry a low-viscosity ink directly onto the film.

The inks are generally dispersed or dissolved in a low viscosity carrier. Exemplary solvents are aliphatic hydrocarbons with common binder types, such as polyamide, shellac, nitro-cellulose, and styrene-maleic. Generally, solvent-based inks include non-catalytic, block urethane resin, which generally demonstrate superior durability over traditional flexographic binders, such as styrene-maleic, rosin-maleic, and acrylic solutions. Desired solvent blends include various acetates such as ethyl acetate, N-propyl acetate, isopropyl acetate, isobutyl acetate, N-butyl acetate, and blends thereof; various alcohols including ethyl alcohol, isopropyl alcohol, normal propyl alcohol, and blends thereof; and glycol ethers including Ektasolve® EP (ethylene glycol monopropyl ether), EB (ethylene glycol monobutyl ether), DM (diethylene glycol monomethyl ether), DP (diethylene glycol monopropyl ether), and PM (propylene glycol monomethyl ether), which may be obtained from Eastman Chemical of Kingsport, Tennessee. Other glycols that may also be used are DOWANOL® obtainable from Dow Chemical of Midland, Mich. A desired solvent blend may be a blend of about 50 percent to about 75 percent glycol ether, about 25 percent to about 35 percent N-propyl acetate, and about 15 percent to about 25 percent N-butyl acetate.

Suitable water-based inks that may be used include emulsions that may be stabilized in water-ammonia and may further comprise alcohols, glycols, or glycol ethers as co-solvents. Generally, organic solvents (less than equal to about 7 percent) to water-based inks: alcohols, for example, propan-2-ol may be added for speeding up drying and assisting wetting, glycols, for example, mono propylene glycol to slow down drying, glycol ethers, for example, dipropyl glycol mono methyl ether to aid film formation. Such solvents may be commodity chemicals, commercially available from various companies. Generally, water-based ink includes self-crosslinking acrylic copolymer emulsion, which may have demonstrated superior durability over traditional non-crosslinking binders such as acrylic solutions and dispersion copolymers. Besides the solvent and pigments, the inks may comprise a binder or mixtures thereof. The binder helps stabilize the pigment onto the cover layer 12. Generally, the pigment-to binder ratios is typically from 1:20 to 1:2 and generally ranges up to about 1:1.7.

Waxes may also be included in the ink composition to increase the slip and improve the rub-resistance of the inks of the printed polyolefin substrate. Common classifications of waxes include animal (for example, beeswax and lanolin), vegetable (for example, carnauba and candellilia), mineral (for example, paraffin and microcrystalline), and synthetic (for example. Polyethylene, polyethylene glycol, and Teflon®). A recommended amount is at about 0.5 percent to about 5 percent wax based on the total ink formulation weight.

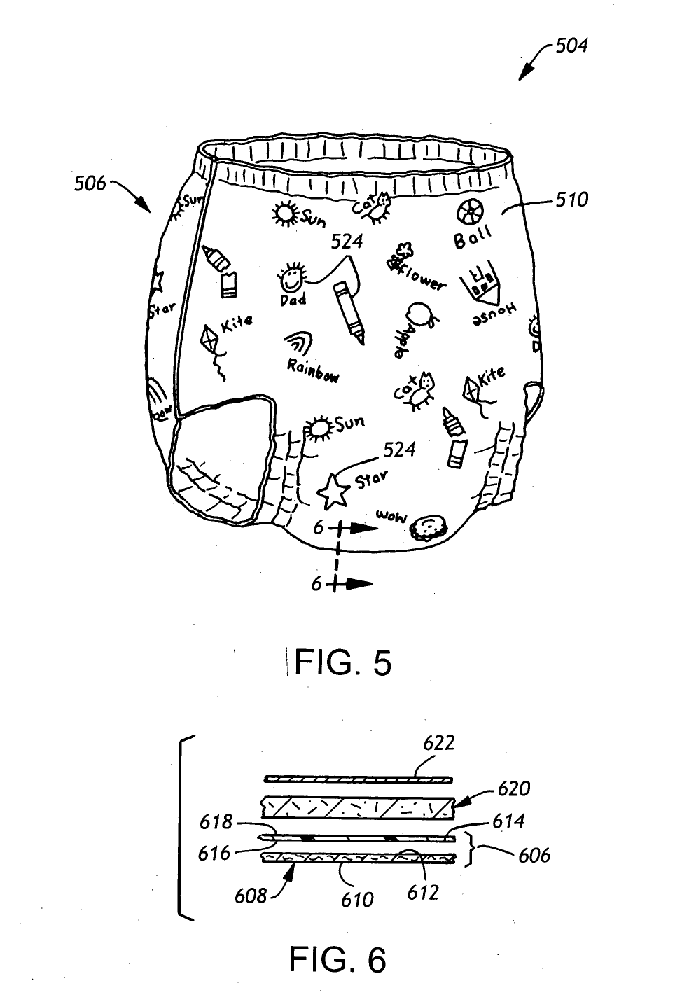

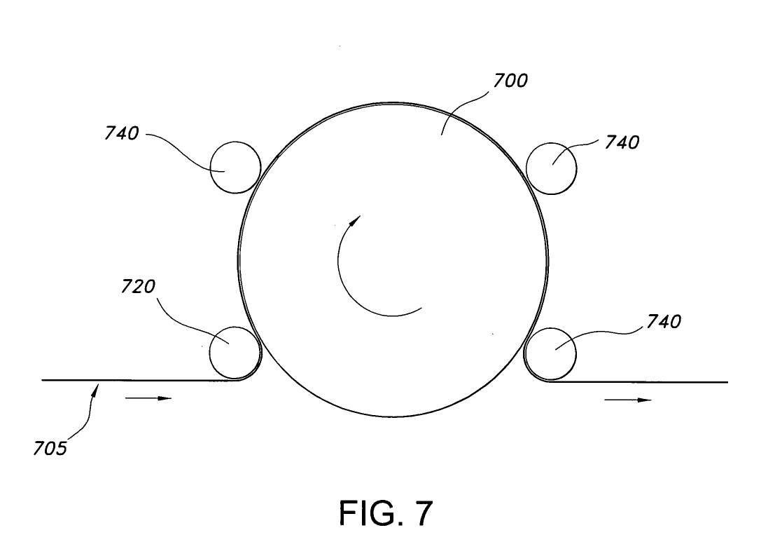

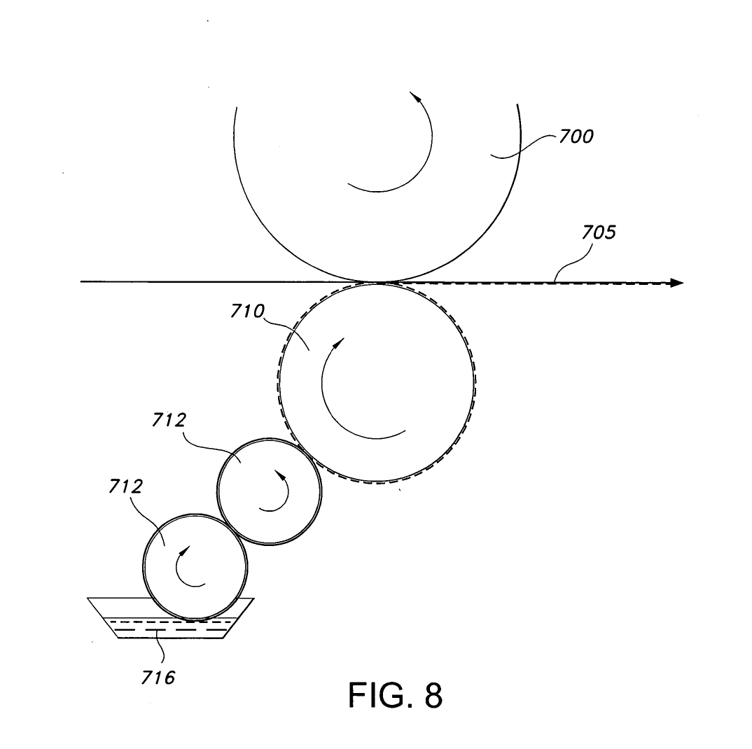

An exemplary printed substrate is included in the illustrated in FIGS. 5 and 6, where FIG. 5 is perspective view of an exemplary training pant and FIG. 6 is an exploded cross-sectional view of FIG. 5 taken along line 6-6. The illustrated exemplary printed substrate is a backsheet 506 of a training pant 504 but could be a printed surface on any of a variety of absorbent articles absorbent upon which printed information or designs might be desirable including, but not limited to, diapers, feminine care products, incontinence products, training pants, swimming pants, wipes, protective garments, medical apparel, packaging and so forth. These and other articles that include hydrophobic substrates upon which printing is desired are well known.

One way to make these products more appealing is to print in bright colors on the products. For example, in FIGS. 5 and 6, training pant 504 comprises a backsheet 506, which can be a two-layered laminate that includes a nonwoven polyolefin fibrous web 608 suitably joined to a liquid impervious film 614. Web 608 has opposed surfaces such as inner surface 612 and outer visible surface 510. Film 614 has opposed surfaces such as surface 616 that faces toward web inner surface 612 and surface 618 that faces toward absorbent composite 620. A liquid permeable topsheet 622 is positioned on the side of absorbent composite 520 opposite to backsheet 506, and is the layer that is against the skin of the wearer. It is outer visible surface 510 of nonwoven polyolefin fibrous web 508 that presents or forms the outermost, visible surface of training pant 504 and on which images 524 are printed. A number of intricate, registered images on the outer visible surface of the backsheet or outer cover; by outer “visible” surface is meant that surface of the product that is visible when the product is worn.

Topsheet 622 can be made of any suitable liquid permeable material, and absorbent composite 620 can be made of any suitable absorbent materials appropriate for the intended use of the particular product. If desired, backsheet 506 can comprise only a liquid permeable layer, such as nonwoven polyolefin fibrous web 508, or can comprise a two-layered laminate as described above. More detailed descriptions of a training pant can be found in U.S. Pat. No. 4,940,464, the entire contents of which are hereby incorporated by reference herein. The colored images may be printed on an underlying layer, such as a film layer, or on the outermost layer, such as a nonwoven layer. For example, with reference to FIG. 6, images 524 can be printed on inner surface 612 of web 608, surface 616 of film 614, surface 618 of film 614, or another surface.

Yet another exemplary method of treating a surface is illustrated in FIGS. 7 and 8. FIG. 7 schematically illustrates a flexographic printing method that includes a treatment step in accordance with the present invention. FIG. 8 is an enlarged view of an exemplary printing station 710 that may be used to apply a treatment composition of the present invention on a substrate 705. In one embodiment, a first treatment/printing station 720 is used to apply a treatment composition of the present invention. A substrate 705 is forwarded to drum 700 so that the substrate 705 is conveyed to printing stations 720 and 740. The printing stations 740 may be used to apply inks of varying colors, for example, magenta, cyan, green and so forth. Dryers may be inserted and employed between printing stations. Each station 710 or 740 includes a printing roll 710 that may include a raised pattern or, in some instances, a flat surface to transfer an ink composition and, in one desirable embodiment, a treatment composition at the first station 720 on to the substrate 705. Each station includes metering rolls 712 and a tray 716 to supply and transfer a composition, ink or treatment composition, to the printing roll 710.

The present invention is further illustrated by the following examples which are representative of the invention although other examples will be apparent to those skilled in the art and are intended to be covered by the claims.

### COMPARATIVE EXAMPLES

Samples of a 1.0 ounce per square yard (osy) a breathable HUGGIES diaper outercover laminate were printed with three different colors of ink: green, blue and purple. The inks were obtained from Sun Chemical Mexico. The inks used to make the following Examples included M04Z-214FF yellow, M04Z-215FF cyan, M04Z-216FF black, M04Z-217FF magenta, M03Z-486FF green and M03Z-488FF optical brightener.

The breathable diaper outercover laminates comprised a 0.5 osy polypropylene spunbonded nonwoven fabric laminated to a 0.5 osy film. The samples were printed on the spunbonded fabric side of the laminate using a flexographic printing method with a PYROFLEX flexographic ink formulation. Specifically, 0.75-inch by 4.5-inch rectangles were printed on the surface of the sample materials. The overall print coverage of the samples was about 28 percent. These printed samples were tested for ink adhesion using the test method described above. A minimum crockfastness number (CFN) of 3.0 is desired.

### EXAMPLES

Samples of the printed breathable HUGGIES diaper outercover laminates of the Comparative Examples above were treated with a 25 weight percent aqueous solution of CIRRASOL PP823 surfactant obtained from Uniquema of Wilmington, Del. The surfactant treated examples were then printed on the nonwoven fabric surface of the breathable laminate with flexographic ink formulation as described above.

The above examples of the present invention and the Comparative Examples were tested for crockfastness using the test method described above. The crockfastness test is an indication of a printed sample's ink adhesion, specifically an indication of a printed sample's ability to resist abrasion. A summary of results of the testing are presented in Table 1 below.

TABLE 1

| Sample Color vs. | | | | | |
|---|---|---|---|---|---|
| Crock Fastening Rating | | | | | |
| (CFN) | Yellow | Blue | Pink | Black | Orange |
| COMPARATIVE EXAMPLES | 3.88 | 3.63 | 2.75 | 2.75 | 3.75 |
| TREATED EXAMPLES | 4.50 | 4.50 | 3.63 | 4.0 | 4.63 |

*sample size N = 4

Treatment of the outercover laminate with CIRRASOL PP 823 surfactant improved the crockfastness of the yellow printed images by about 0.6 CFN. Treatment of the outercover laminate with CIRRASOL surfactant improved the crockfastness of the blue printed image by about 0.9. Treatment of the outercover laminate with CIRRASOL surfactant improved the crockfastness of the pink printed image by about 0.9. Treatment of the outercover laminate with CIRRASOL surfactant improved the crockfastness of the black printed image by about 1.3. And, treatment of the outercover laminate with CIRRASOL surfactant improved the crockfastness of the orange printed image by about 0.9 CFN.

Thus, in accordance with the invention, there has been provided printed substrates, for example nonwoven fabrics, films, and foams and methods of improving the adhesion of an ink composition to a hydrophobic substrate. While the invention has been illustrated by specific embodiments, it is not limited thereto and is intended to cover all equivalents as come within the broad scope of the claims.

We claim:

1. A printed polymeric substrate comprising:
a polymeric substrate;
a coating or other surface treatment on at least a portion of the polymeric substrate, the coating comprising at least one surfactant composition; and
a pattern or other indicia comprising an ink composition printed on at least a portion of the portion of the polymeric substrate that is coated or surface treated with the surfactant.

2. The printed polymeric substrate of claim 1 wherein polymeric substrate is a nonwoven, a film or a foam.

3. The printed polymeric substrate of claim 1 wherein the printed polymeric substrate is a laminate that comprises a nonwoven fabric layer and a film layer.

4. The film of claim 4, wherein the laminate has a WVTR of at least about 100 g/m²/24 hours.

5. The printed polymeric substrate of claim 1 wherein the polymeric substrate is a nonwoven fabric that comprises fibers that comprise a polyolefin.

6. The printed polymeric substrate of claim 6 wherein the printed polymer substrate forms or is a component of a protective garment, a medical apparel article, a diaper, a training pant, a feminine care product, a package or a swimming pant.

7. The printed polymeric substrate of claim 1 wherein the surfactant composition has a HLB value of about 10.

8. The printed polymeric substrate of claim 1 wherein the surfactant composition is selected from the group consisting of an ethoxylated hydrogenated castor oil and sorbitan monooleate, and mixtures thereof.

9. The printed polymeric substrate of claim 1 wherein the surfactant composition comprises an ethoxylated hydrogenated castor oil and sorbitan monooleate.

10. The printed polymeric substrate of claim 10 wherein the surfactant composition further comprises a botanical extract.

11. The printed polymeric substrate of claim 11 wherein the botanical extract is selected from the group consisting of aloe Vera, vitamin E, cotton extract, chamomile, jojoba, sunflower oil, citric oils, carrot oils, avocado oil, almond oil, wheat germ, mint, olive oil, vitamin E, vitamin D, vitamin A, isopropyl palmitate, eucalyptus oil, lavender, peppermint oil and derivatives thereof, and mixtures thereof.

12. A method of improving the adhesion of an ink composition to a hydrophobic substrate, the method comprising:
contacting at least a portion of a hydrophobic substrate with a composition that comprises a surfactant; and
printing a pattern or other indicia on at least a portion of the portion of the hydrophobic substrate that was contacted with the surfactant.

13. The method of claim 12 wherein the treatment composition has a HLB value of about 10.

14. The method of claim 12 wherein the treatment composition comprises an ethoxylated hydrogenated castor oil, sorbitan monooleate, or a mixture thereof.

15. The method of claim 12 wherein the treatment composition further comprises botanical extract is selected from the group consisting of: aloe vera; vitamin E; cotton extract; a derivative of aloe vera, vitamin E, or cotton extract; and mixtures thereof.

16. The method of claim 12 wherein treatment composition further comprises alkyldemethyl benzylammonium chloride, allontoin (5-ureidohydantoin), aluminium acetate, aluminum hydroxide, amylum, balsam peru, benzethonium chloride, bismuth subnitrate, boric acid, calamine, calcium carbonate, camphor, casein, cod liver oil, cysteine hydrocholyde, dibucaine, disperodon, glycerin, lanolin, petrolatum, phenol, silic one sorbitane, talc, zinc oxide, zinc or a mixture of them

17. The method of claim 12 wherein polymeric substrate is a hydrophobic film, foam or nonwoven substrate.

18. The method of claim 12 wherein the polymeric substrate comprises a spunbonded nonwoven fabric.

19. A method of improving the adhesion of an ink composition to a hydrophobic, spunbonded nonwoven substrate, the method comprising:
forming a hydrophobic, spunbonded nonwoven substrate;
contacting at least a portion of the hydrophobic, spunbonded nonwoven substrate with a treatment composition that comprises an ethoxylated hydrogenated castor oil, sorbitan monooleate and a botanical extract;
and printing a pattern or other indicia on at least a portion of the portion of the hydrophobic, spunbonded nonwoven substrate that was contacted with the treatment composition.

20. The method of claim 19 wherein the treatment composition further comprises at lest one botanical extract selected from the group consisting of aloe vera, vitamin E, cotton extract, chamomile, jojoba, sunflower oil, citric oils, carrot oils, avocado oil, almond oil, wheat germ, mint, olive oil, vitamin D, vitamin A, isopropyl palmitate, eucalyptus oil, lavender, or peppermint oil, and derivatives thereof.
